(19) United States
(12) Patent Application Publication
(10) Pub. No.: US 2024/0264456 A1
(43) Pub. Date: Aug. 8, 2024

(54) ACCOMMODATION STATE OF EYE FROM POLARIZED IMAGING

(71) Applicant: Meta Platforms Technologies, LLC, Menlo Park, CA (US)

(72) Inventors: Mantas Zurauskas, Redmond, WA (US); Onur Can Akkaya, Los Altos, CA (US); Salim Boutami, Seattle, WA (US); Khalid Omer, Kirkland, WA (US)

(21) Appl. No.: 18/522,874

(22) Filed: Nov. 29, 2023

Related U.S. Application Data
(60) Provisional application No. 63/442,866, filed on Feb. 2, 2023.

(51) Int. Cl. G02B 27/28; G02B 27/01

(52) U.S. Cl. CPC G02B 27/286; G02B 27/0172; G02B 27/283

(57) ABSTRACT

An eyebox region is illuminated with polarized light. A polarized image of an eye in the eyebox regions is captured while the polarized light illuminates the eyebox region. The polarized image is compared to another polarized image to determine an accommodation state of the eye.

### CROSS-REFERENCE TO RELATED APPLICATIONS

This application claims priority to U.S. provisional Application No. 63/442,866 filed Feb. 2, 2023, which is hereby incorporated by reference.

### TECHNICAL FIELD

This disclosure relates generally to optics, and in particular to imaging.

### BACKGROUND INFORMATION

Virtual reality (VR), augmented reality (AR), and mixed reality (MR) devices may utilize eye-tracking to enhance the user experience and increase functionality. Some eye-tracking systems illuminate an eyebox region with one or more LEDs and then image the eyebox region using temple-mounted cameras. Head mounted displays (HMDs) also present virtual images to the user.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head mounted display (HMD) that may include an eye accommodation sensing system, in accordance with aspects of the disclosure.

FIGS. 2A and 2B include illustrations of eye images when the eye is in a near-focus accommodation state compared to a far-focus accommodation state, in accordance with aspects of the disclosure.

FIG. 3 shows illustrations of images that were captured with a polarization-sensitive sensor while the eye was illuminated by polarized light, in accordance with aspects of the disclosure.

FIG. 4 illustrates an example system where an eye is illuminated with an illumination module, in accordance with aspects of the disclosure.

FIG. 5A illustrates an eye accommodation sensing system including a scanner, a sensor, and processing logic, in accordance with aspects of the disclosure.

FIG. 5B illustrates a plurality of lens scan points, in accordance with aspects of the disclosure.

FIG. 6 illustrates a system where two eyes are imaged using two cameras, in accordance with aspects of the disclosure.

FIG. 7 illustrates an example system where an active polarization modulator rotates linearly polarized light from the light source to illuminate an eye, in accordance with aspects of the disclosure.

FIG. 8 illustrates a flow chart of an example process of determining an accommodation state of an eye, in accordance with aspects of the disclosure.

### DETAILED DESCRIPTION

Embodiments of eye accommodation sensing are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

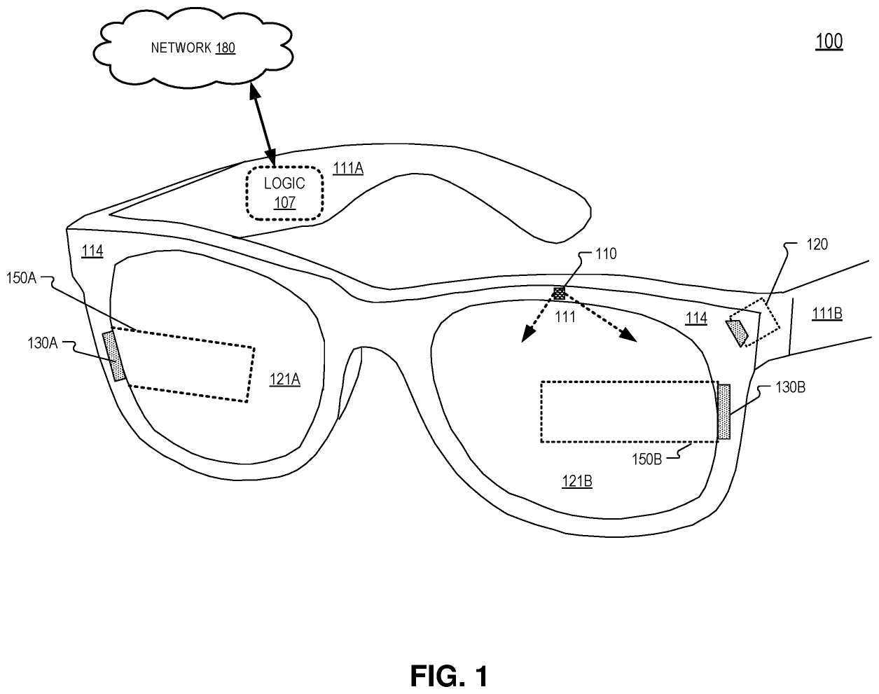

Techniques and devices for eye accommodation sensing are disclosed herein. A head mounted device or head mounted display may perform methods included in this disclosure in order to determine an accommodation state of the eye. In the case of a head mounted display (HMD), virtual images presented to the user may be adjusted based on the accommodation state of the eye, for example. Determining the accommodation state of the eye may permit calculations of three-dimensional (3D) gaze coordinates. An eyebox that will include an eye of a user may be illuminated with polarized light. The polarized light may be near-infrared light (e.g. 850 nm) emitted by a laser. Images of the eye may be captured by an image sensor or a scanner that is polarization sensitive. In an implementation, the accommodation state of the eye is determined, at least in part, by the shape of an iris of the eye in the images. In an implementation, the accommodation state of the eye is determined by the shapes of polarization regions of an iris of the eye in the images. In an implementation, the accommodation state of the eye is determined, at least in part, by the shape of a lens of the eye in the images. In an implementation, the accommodation state of the eye is determined by both the shape of the lens and the shape of the iris in the images. Analyzing the degree of polarization and/or the angle of polarization in the image may assist in analyzing the changes of the shape of the iris and/or the lens. These and other implementations are described in more detail in connections with FIGS. 1-8.

FIG. 1 illustrates a head mounted display (HMD) 100 that may include an eye accommodation sensing system, in accordance with aspects of the present disclosure. HMD 100 includes frame 114 coupled to arms 111A and 111B. Lens assemblies 121A and 121B are mounted to frame 114. Lens assemblies 121A and 121B may include a prescription lens matched to a particular user of HMD 100. The illustrated HMD 100 is configured to be worn on or about a head of a wearer of HMD 100.

In the HMD 100 illustrated in FIG. 1, each lens assembly 121A/121B includes a waveguide 150A/150B to direct image light generated by displays 130A/130B to an eyebox region for viewing by a user of HMD 100. Displays 130A/130B may include a beam-scanning display or a liquid crystal on silicon (LCOS) display for directing image light to a wearer of HMD 100 to present virtual images, for example.

Lens assemblies 121A and 121B may appear transparent to a user to facilitate augmented reality or mixed reality to enable a user to view scene light from the environment around them while also receiving image light directed to their eye(s) by, for example, waveguides 150. Lens assemblies 121A and 121B may include two or more optical layers for different functionalities such as display, eye-tracking, and optical power. In some embodiments, image light from display 130A or 130B is only directed into one eye of the wearer of HMD 100. In an embodiment, both displays 130A and 130B are used to direct image light into waveguides 150A and 150B, respectively. The implementations of the disclosure may also be used in head mounted devices (e.g. smartglasses) that don't necessarily include a display but are configured to be worn on or about a head of a wearer.

Frame 114 and arms 111 may include supporting hardware of HMD 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, HMD 100 may be configured to receive wired power. In one embodiment, HMD 100 is configured to be powered by one or more batteries. In one embodiment, HMD 100 may be configured to receive wired data including video data via a wired communication channel. In one embodiment, HMD 100 is configured to receive wireless data including video data via a wireless communication channel. Processing logic 107 may be communicatively coupled to a network 180 to provide data to network 180 and/or access data within network 180. The communication channel between processing logic 107 and network 180 may be wired or wireless.

In the illustrated implementation of FIG. 1, HMD 100 includes a camera 120 configured to image an eyebox region. Illumination module 110 is configured to illuminate the eyebox region with polarized light that may be near-infrared light to assist camera 120 in imaging the eyebox region. Camera 120 may include a lens assembly configured to focus image light to a complementary metal-oxide semiconductor (CMOS) image sensor, in some implementations. A near-infrared filter that receives a narrow-band near-infrared wavelength may be placed over the image sensor so it is sensitive to the narrow-band near-infrared wavelength while rejecting visible light and wavelengths outside the narrow-band. Near-infrared illuminators (not illustrated) such as near-infrared LEDs or lasers that emit the narrow-band wavelength may be included in illumination module 110 to illuminate the eyebox region with the narrow-band near-infrared wavelength. In an implementation, illumination module 110 includes a diverging LED or laser as a light source to illuminate the eyebox region in addition to a collimated self-mixing interferometry (SMI) module. The SMI module may be configured to measure a distance to an eye with an accuracy of within a few microns at a rate that exceeds 1000 Hz.

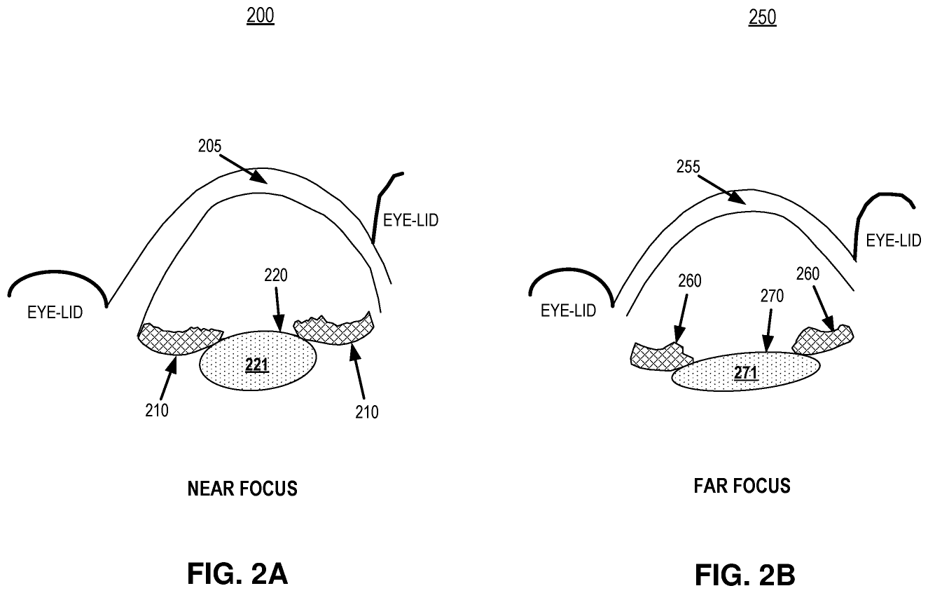

FIGS. 2A and 2B include illustrations of eye images when the eye is in a near-focus accommodation state (FIG. 2A) compared to a far-focus accommodation state (FIG. 2B), in accordance with aspects of the disclosure. Image 200 includes the iris 210, the lens 221, and the cornea 205 of an eye in a near-focus accommodation state. Image 250 includes the iris 260, the lens 271, and the cornea 255 of an eye in a near-focus accommodation state. Eye images 200 and 250 show that the shape of the iris 210/260 and the lens 221/271 are different when the eye is in a near-focus accommodation state (image 200) compared to a far-focus accommodation state (image 250). The shape of lens 221 of the eye changes with the accommodation state of the eye and thus measuring the shape of the lens 221 is indicative of an accommodation state of the eye. In particular, the curvature of the lens 220 (FIG. 2A) and the curvature of lens 270 (FIG. 2B) that is closest to the middle of cornea 205/255 can be measured/imaged to determine the shape of the lens.

Since the iris will follow or track with the changing shape of the lens, the shape of the iris may also be measured to determine, at least in part, the accommodation state of the eye. Iris 210/260 may be easier to image than the actual front surface 220/270 of the lens 221/271 due to the iris 210/260 providing a stronger reflection signal of polarized light than the front surface 220/270 of lens 221/271.

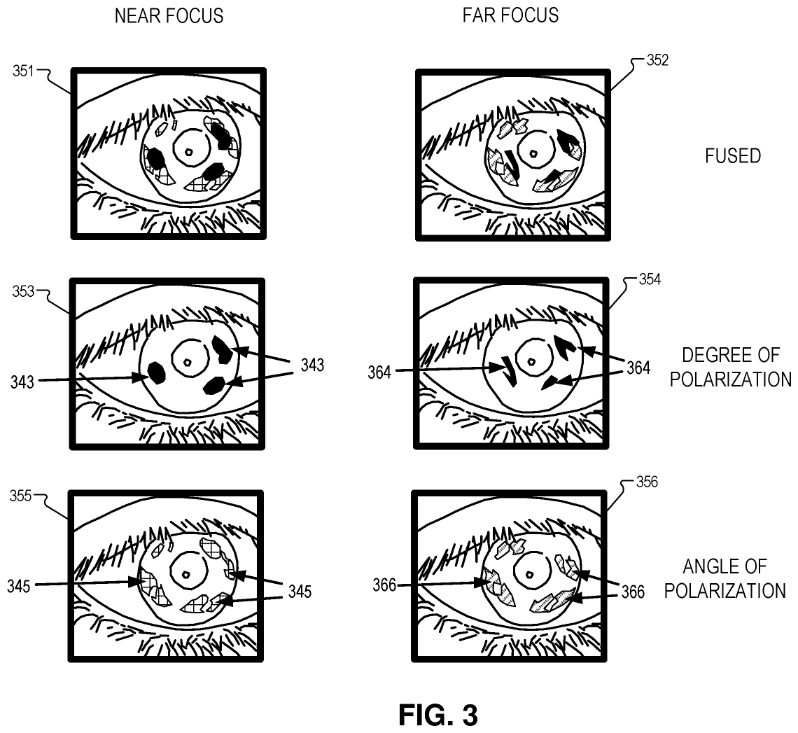

Imaging the shapes of the iris and lens may be assisted and enhanced by illuminating the eye with polarized light. FIG. 3 shows images 351-356 that were captured with a polarization-sensitive sensor while the eye was illuminated by polarized light, in accordance with aspects of the disclosure. The polarization-sensitive sensor may be an image sensor with pixel groups that are sensitive to different polarization orientations (e.g. horizontal linear polarization, vertical linear polarization, right-hand circularly polarized light, or left-hand circularly polarized light). In an implementation, the polarization-sensitive sensor is a sensor that receives a particular polarization orientation of reflected light that is scanned to different points on the eye.

Image 353 shows a degree of polarization image of the iris when the eye is in a near-focus accommodation state while image 354 shows a degree of polarization image of the iris when the eye is in a far-focus accommodation state. Notably, the dark shapes/regions 343 within the iris have changed in image 353 to shapes/regions 364 in image 354. This change may be due to the change of the polarization orientation of the light reflecting from the eye due to differing propagation paths (in transmission and/or reflection). In some implementations, the analysis of the changes in the shapes/regions of the iris can determine the accommodation state of the eye.

Image 355 shows an angle of polarization image of the iris when the eye is in a near-focus accommodation state while image 356 shows an angle of polarization image of the iris when the eye is in a far-focus accommodation state. Here again, the shapes/region 345 within the iris have changed in image 355 to shapes/regions 366 in image 356. This may be due to the change of the angle of polarization of the light reflecting from the eye due to differing propagation paths (in transmission and/or reflection). In some implementations, the analysis of the changes in the shapes/regions of the iris can determine the accommodation state of the eye. Images 351 illustrates a fused image of images 353 and 355 and images 352 illustrates a fused image of images 354 and 356.

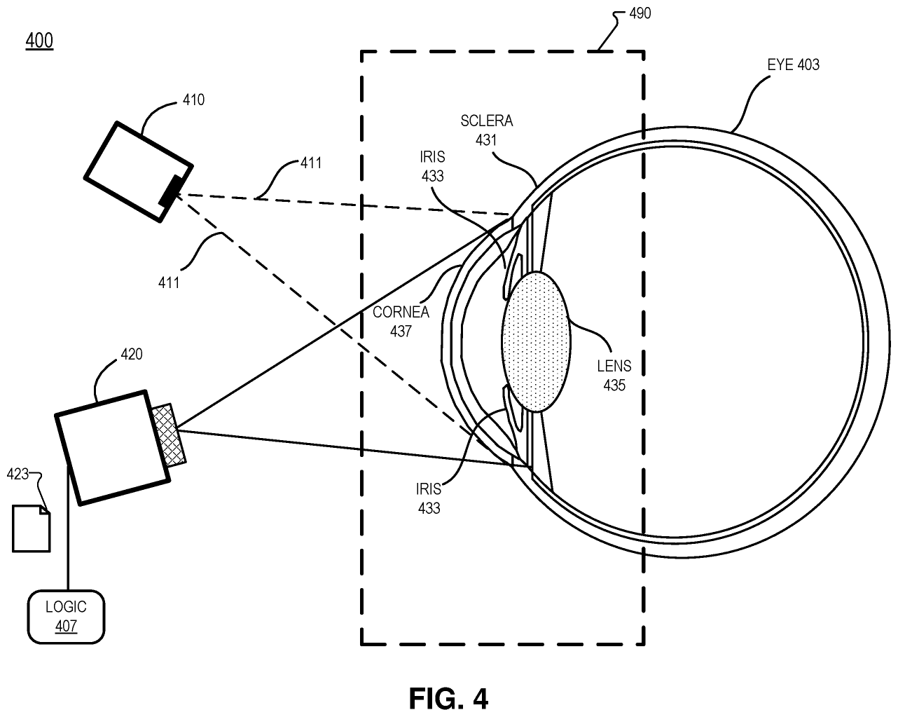

FIG. 4 illustrates an example system 400 where eye 403 is illuminated with an illumination module 410, in accordance with aspects of the disclosure. Illumination module 410 illuminates the eyebox region 490 with polarized light 411 that has a known polarization state. Polarization-sensitive camera 420 captures images of the eye 403 that includes cornea 437, iris 433, sclera 431 and lens 435. Illumination module 410 may include illuminators such as LEDs or lasers. Polarized light 411 may be linearly polarized light or circularly polarized light, in different implementations. Polarization-sensitive camera 420 may include wavelength and/or polarization filters so that the image sensor is only sensitive to a particular polarization orientation and/or wavelengths of image light from eye 403. Camera 420 may have groups of image pixels that are sensitive to image light with different polarization orientations (e.g. p-polarized light, s-polarized light, right-hand circularly polarized light, or left-hand circularly polarized light). In some implementations, individual pixels of the image sensor have polarized filters disposed over the image pixels so that adjacent pixels in the image pixel array will receive different orientations of polarized light.

Camera 420 may capture a series of images 423 of eye 403. Processing logic 407 may receive the images 423 from camera 420. Polarization profilometry may be used to measure the shape changes of the iris in response to different accommodation states of eye 403. In an implementation, a second polarized image is compared to a first polarized image to determine changes in the iris shape that indicate an accommodation state of eye 403. The comparison or polarization profilometry may be performed by processing logic 407.

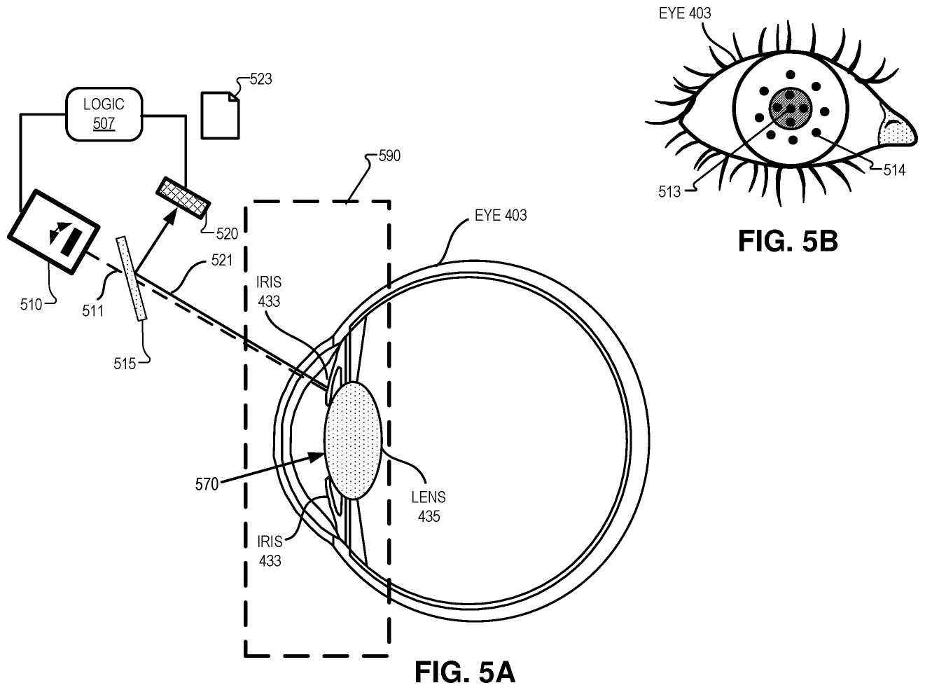

FIG. 5A illustrates an eye accommodation sensing system 500 including a scanner 510, a sensor 520, and processing logic 507, in accordance with aspects of the disclosure. Scanner 510 may be a point scanner configured to direct a polarized beam 511 to eye 403. Scanner 510 may be a micro-electro-mechanical systems (MEMS) device. Scanner 510 may include a rotating mirror for directing the polarized beam 511 to different scan points. The polarized beam 511 may be emitted from a highly collimated source (e.g. a laser). Sensor 520 may be a photodiode or other photosensitive element. In the illustrated implementation, a beam splitter 515 is disposed between scanner 510 and eyebox region 590. Beam splitter 515 may be a polarized beam splitter, in some implementations.

In operation, scanner 510 directs a polarized beam 511 (having a known polarization orientation) to a point on eye 403. The polarized beam 511 propagates through beam splitter 515 and reflects or scatters off the iris 433 or front surface 570 of lens 435. If beam splitter 515 is a polarized beam splitter, it may be configured to pass the polarization orientation of polarized beam 511 received from scanner 510 and reflect the orthogonal polarization orientation. The reflected/scattered beam propagates back toward beam splitter 515 as returning light 521. Beam splitter 515 reflects/directs all or a portion of returning light 521 to sensor 520. Sensor 520 may generate a signal 523 for that specific point that was scanned and that signal 523 may be provided to processing logic 507. Scanner 510 may progress or iterate to additional scan points on eye 403 and sensor 520 may generate a series of signals 523 corresponding with the additional scan points in order to generate a polarized image including the plurality of scan points. The points may be on the iris 433 or on the surface 570 of lens 435, or both. Scanner 510 may scan through five, ten, one-hundred, or any number of points in order to generate a polarized image with sufficient points to determine the accommodation state of eye 403.

FIG. 5B illustrates an eye 403 and a plurality of lens scan points 513 (within the pupil). Lens scan points 513 would be for measuring the shape of lens 435 to determine an accommodation state of eye 403. Iris scan points 514 of iris 433 are for determining the shape of iris 433 in order to determine an accommodation state of eye 403. Scanner 510 may be driven to a pre-defined scan path (including a predefined number of scan points) to capture lens scan points and/or iris scan points. Processing logic 507 may receive signals 523 representative of returning light 521 from a scan point incident on sensor 520 as well as drive scanner 510 to scan the polarized beam 511 to different points within eye 403. Processing logic 507 may be configured to determine an accommodation state of an eye in the eyebox region 590 by comparing a first polarized image having first scan points of the eye with a second polarized image that includes second scan points of the eye. The second polarized image may be captured subsequent to the first polarized image.

Using scanner 510 and sensor 520 of FIG. 5A may be faster for capturing and/or analyzing image data of eye 403 when compared to the camera implementation of FIG. 4. The implementation of FIGS. 5A and 5B may also require less power and less processing resources.

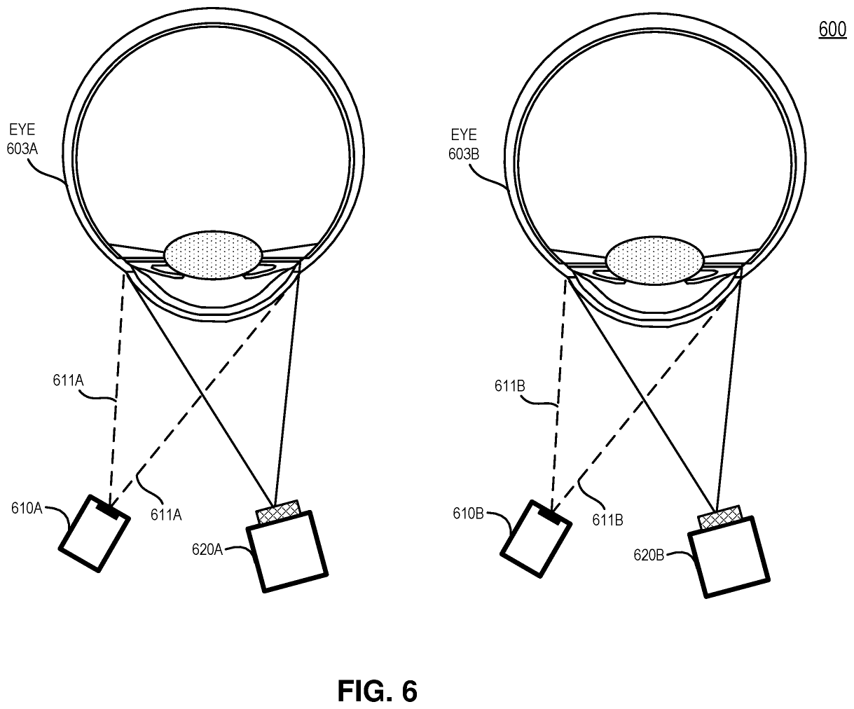

FIG. 6 illustrates a system 600 where two eyes are imaged using two cameras, in accordance with aspects of the disclosure. System 600 includes two illumination modules 610A and 610B and two polarization-sensitive cameras 420A and 420B. Illumination module 610A illuminates the eyebox region of eye 603A with polarized light 611A that has a known polarization state. Polarization-sensitive camera 620A captures images of eye 603A. Illumination module 610B illuminates the eyebox region of eye 603B with polarized light 611B that has a known polarization state. Polarization-sensitive camera 620B captures images of eye 603B. System 600 may include two of system 400 so that system 600 can image both eyes. The images from polarization-sensitive cameras 420A and 420B may be provided to a same processing logic (not illustrated), in some implementations. Imaging both eyes may provide convergence data that may assist in determining the accommodations states of the eye. Specifically, the polarization information from the images captured by system 600 may be used in combination with the convergence data (measuring where the gaze converges) of the eyes to determine the accommodation state of the user.

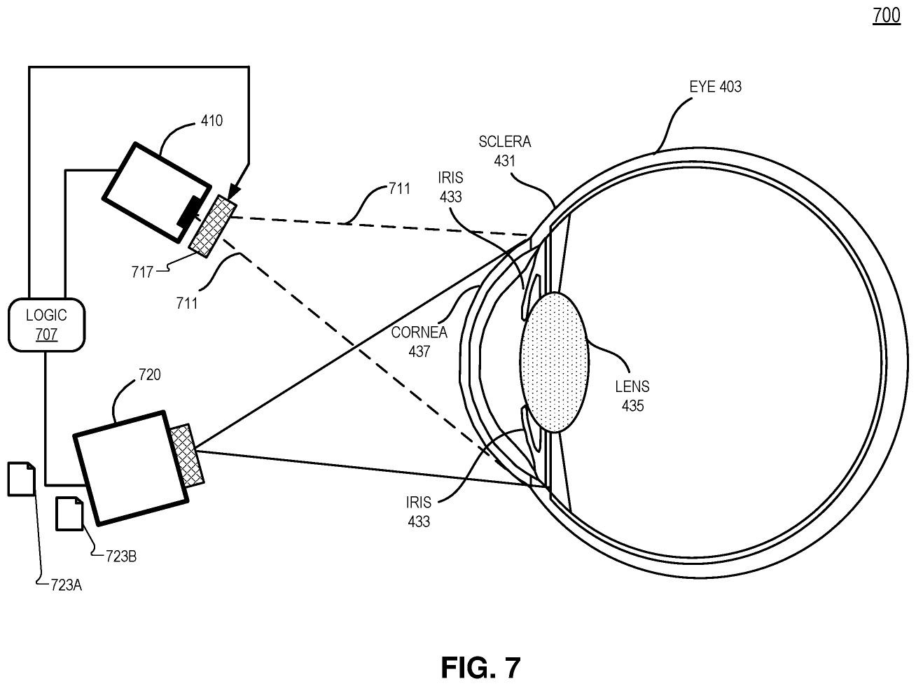

FIG. 7 illustrates an example system 700 where an active polarization modulator 717 rotates linearly polarized light from the light source to illuminate eye 403, in accordance with implementations of the disclosure. System 700 is similar to system 400 although processing logic 707 may drive active polarization modulator 717 to change the polarization state of polarized light 711. Processing logic may also receive images 723 from camera 720. The images 723 generated by camera 420 may be captured while polarized light 711 has different polarization orientations. For example, image 723A may be captured while polarized light 711 has a first polarization orientation and image 723B may be captured while polarized light 711 has a second polarization orientation that is different (e.g. orthogonal to) from the first polarization orientation. Camera 720 may be a camera with a single polarizer mounted across the image sensor or a polarization-sensitive camera having pixel-by-pixel polarizer filters.

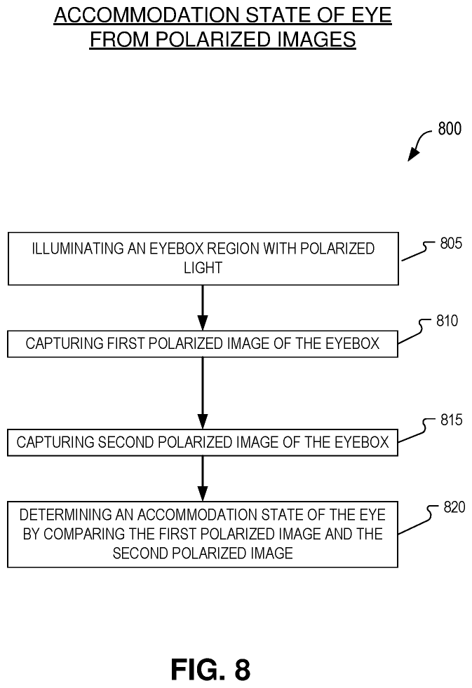

FIG. 8 illustrates a flow chart of an example process 800 of determining an accommodation state of an eye, in accordance with aspects of the disclosure. The order in which some or all of the process blocks appear in process 800 should not be deemed limiting. Rather, one of ordinary skill in the art having the benefit of the present disclosure will understand that some of the process blocks may be executed in a variety of orders not illustrated, or even in parallel. All or a portion of the process block in process 800 may be executed by processing logic 407, 507, or 707, for example. All or a portion of the process block in process 800 may be executed by processing logic included in a head mounted device. All or a portion of the process block in process 800 may be executed by processing logic included in a head mounted display.

In process block 805, an eyebox region is illuminated with polarized light. In an implementation, illuminating the eyebox region with the polarized light includes scanning the polarized light with a point scanner.

In process block 810, a first polarized image of an eye (in an eyebox region) is captured while the polarized light illuminates the eyebox region. The first polarized image is captured by a polarization-sensitive sensor (e.g. a camera or sensor 520). The polarization-sensitive sensor may include a polarization-sensitive camera including pixels configured to image different polarization orientations. In an implementation, the polarization-sensitive sensor includes a polarization-sensitive camera including polarization filters that change in time.

In process block 815, a second polarized image of an eye (in the eyebox region) is captured while the polarized light illuminates the eyebox region. The second polarized image is also captured by a polarization-sensitive sensor (e.g. a camera or sensor 520).

In process block 820, an accommodation state of the eye is determined by comparing the first polarized image and the second polarized image.

In an implementation, process 800 further includes adjusting a virtual image of a head mounted display in response to the determined accommodation state of the eye.

In an implementation, determining the accommodation state of the eye includes comparing a degree of polarization in the first polarized image and the second polarized image.

In an implementation, determining the accommodation state of the eye includes comparing an angle of polarization in the first polarized image and the second polarized image.

In an implementation, determining the accommodation state of the eye includes comparing a first iris region in the first polarized image with a second iris region in the second polarized image. In some implementations, the iris shape is used as a secondary indicator of lens shape to make a determination on eye accommodation. In this implementation, determining the accommodation state of the eye also includes determining the curvature of the lens of the eye based on the first polarized image and the second polarized image.

In an implementation, determining the accommodation state of the eye is determined based on a curvature of an iris of the eye in the first polarized image and the second polarized image. If the curvature of the iris is flatter, the accommodation state of the eye may be a far-focus state, and if the iris is more curved, the accommodation state of the eye may be a near-focus state.

In some implementations, the accommodation state of the eye is determined by the curvature of the iris and the curvature of the lens.

In an implementation, determining the accommodation state of the eye is determined based on a curvature of a lens of the eye in the first polarized image and the second polarized image.

In an implementation, determining the accommodation state of the eye is determined based on a radius of a cornea of the eye in the first polarized image and the second polarized image.

In an implementation, process 800 further includes capturing self-mixing interferometry data with one or more self-mixing interferometer (SMI) sensors. The SMI sensor(s) may be included in the same head mounted device as a polarization camera that captures the first polarized image and the second polarized image. The SMI sensor is configured to measure the distance to the eye and the velocity of the eye. Determining the accommodation state of the eye may further include analyzing the self-mixing interferometry data. The self-mixing interferometry data may be captured between the capturing of the first polarized image and the second polarized image in order to fill in time-gaps between the frames of the first polarized image and the second polarized image.

Embodiments of this disclosure may be implemented in a head mounted device of head mounted display. For example, the light sources, scanners, cameras, and optical components may be included in a system of a head mounted device or head mounted display. The cameras of the disclosure may include a complementary metal-oxide semiconductor (CMOS) image sensor. An infrared filter that receives a narrow-band infrared wavelength may be placed over the image sensor so it is sensitive to the narrow-band infrared wavelength while rejecting visible light and wavelengths outside the narrow-band. Light sources such as infrared LEDs or vertical-cavity surface-emitting lasers (VCSELS) that emit the narrow-band wavelength may be oriented to illuminate the eye with the narrow-band infrared wavelength that matches the infrared filter of the camera.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I2C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method comprising:
illuminating an eyebox region with polarized light;
capturing a first polarized image of an eye in the eyebox region while the polarized light illuminates the eyebox region, wherein the first polarized image is captured with a polarization-sensitive sensor;
capturing a second polarized image of the eye while the polarized light illuminates the eyebox region, wherein the second polarized image is captured with the polarization-sensitive sensor; and
determining an accommodation state of the eye by comparing the first polarized image and the second polarized image.

2. The method of claim 1, wherein determining the accommodation state of the eye includes comparing a degree of polarization in the first polarized image and the second polarized image.

3. The method of claim 1, wherein determining the accommodation state of the eye includes comparing an angle of polarization in the first polarized image and the second polarized image.

4. The method of claim 1, wherein determining the accommodation state of the eye includes comparing a first iris region in the first polarized image with a second iris region in the second polarized image.

5. The method of claim 1, wherein determining the accommodation state of the eye is determined based on a curvature of an iris of the eye in the first polarized image and the second polarized image.

6. The method of claim 5, wherein the curvature of the iris is flatter, the accommodation state of the eye is far-focus, and wherein the curvature of the iris is more curved, the accommodation state of the eye is near-focus.

7. The method of claim 1, wherein determining the accommodation state of the eye is determined based on a curvature of a lens of the eye in the first polarized image and the second polarized image.

8. The method of claim 1, wherein determining the accommodation state of the eye is determined based on a radius of a cornea of the eye in the first polarized image and the second polarized image.

9. The method of claim 1, wherein the method is performed by a head mounted device.

10. The method of claim 1, wherein the method is performed by a head mounted display.

11. The method of claim 1, wherein the polarization-sensitive sensor includes a polarization-sensitive camera including pixels configured to image different polarization orientations.

12. The method of claim 1, wherein the polarization-sensitive sensor includes a polarization-sensitive camera including polarization filters that change in time.

13. The method of claim 1, wherein illuminating the eyebox region with the polarized light includes scanning the polarized light with a point scanner.

14. The method of claim 1, further comprising:
adjusting a virtual image of a head mounted display (HMD) in response to the determined accommodation state of the eye.

15. A head mounted device comprising:
an illumination module configured to illuminate an eyebox region with polarized light;
a camera configured to capture a first polarized image of the eyebox region while the polarized light illuminates the eyebox region; and
processing logic configured to determine an accommodation state of an eye in the eyebox region by comparing the first polarized image with a second polarized image.

16. The head mounted device of claim 15, wherein determining the accommodation state of the eye includes comparing a degree of polarization and an angle of polarization in the first polarized image and the second polarized image.

17. The head mounted device of claim 16, wherein the degree of polarization and an angle of polarization are used to determine an eye lens shape to determine the accommodation state of the eye.

18. The head mounted device of claim 17, wherein determining the accommodation state of the eye is determined is also based on a curvature of an iris of the eye in the first polarized image and the second polarized image.

19. The head mounted device of claim 15 further comprising:
an active polarization modulator configured to modulate the polarized light between a first polarization orientation and a second polarization orientation, the active polarization modulator receiving the polarized light from the illumination module.

20. A head mounted device comprising:
a scanner configured to scan lens points of an eye lens within an eyebox region with a polarized beam;
a sensor configured to generate a first polarized image by sensing a returning beam received from the lens points within the eyebox region, wherein the returning beam is the polarized beam reflecting or scattering from the eyebox region; and
processing logic configured to determine an accommodation state of an eye in the eyebox region by comparing the first polarized image with a second polarized image that includes second lens points of the eye lens.
